(19) United States
(12) Patent Application Publication
(10) Pub. No.: US 2024/0299145 A1
(43) Pub. Date: Sep. 12, 2024

(54) PORTABLE ORAL IRRIGATOR

(71) Applicant: RISUN TECHNOLOGY (SHENZHEN) LIMITED, Shenzhen (CN)

(72) Inventors: Hongtao ZHOU, Shenzhen (CN); Dongbao LI, Shenzhen (CN)

(73) Assignee: RISUN TECHNOLOGY (SHENZHEN) LIMITED, Shenzhen (CN)

(21) Appl. No.: 18/664,802

(22) Filed: May 15, 2024

Related U.S. Application Data
(63) Continuation of application No. PCT/CN2023/130548, filed on Nov. 8, 2023.

(30) Foreign Application Priority Data
Dec. 29, 2022 (CN) 202211707023.7

(51) Int. Cl. A61C 17/02; A61C 17/028

(52) U.S. Cl. CPC A61C 17/0202; A61C 17/028; A61C 2204/002

(57) ABSTRACT

A portable oral irrigator includes an oral irrigator body, a pump assembly and a nozzle. An oral irrigator water tank is slidably clamped in the oral irrigator body, the pump assembly is installed in the oral irrigator body, an oral irrigator inner cover is installed in the oral irrigator body, an end of the oral irrigator body is provided with an oral irrigator upper cover detachably connected to the oral irrigator body, a first magnet is installed in the oral irrigator upper cover, the oral irrigator upper cover is provided with a first opening for inserting the nozzle, an end of the nozzle is sleeved with a second magnet adsorbing and matching with the first magnet, and the pump assembly pumps water from the oral irrigator water tank and spray water out from the nozzle.

### CROSS-REFERENCE TO RELATED APPLICATIONS

The present application is a continuation application of International Application No. PCT/CN2023/130548, filed on Nov. 8, 2023, which claims priority to Chinese patent application No. 202211707023.7, and filed on Dec. 29, 2022. The entire contents of the above-mentioned applications are incorporated herein by reference.

### TECHNICAL FIELD

The present application relates to the technical field of oral irrigators, and in particular to a portable oral irrigator.

### BACKGROUND

The oral irrigator is a structure used to care for the oral cavity. The oral irrigator uses a certain pressure to eject a cleaning water column from the nozzle of the oral irrigator to clean the user's oral cavity. Currently, oral irrigators are widely used in in people's daily lives.

In the related art, a conventional oral irrigator has a nozzle installed at the oral irrigator through a circlip, and a release button is provided to facilitate the user to take out the nozzle. However, since the nozzle is clamped with the circlip, after long-term use, the elastic force of the circlip is prone to deformation or the slot on the nozzle is seriously worn, which leads to unstable installation of the nozzle and affects the normal use of the oral irrigator.

Therefore, how to provide a portable oral irrigator to facilitate the disassembly and assembly of the nozzle and prevent the nozzle from being worn has become an urgent technical problem to be solved.

### SUMMARY

The main purpose of the present application is to provide a portable oral irrigator to facilitate the disassembly and assembly of the nozzle and prevent the nozzle from being worn.

In view of this, according to a first aspect, an embodiment of the present application discloses a portable oral irrigator, which includes: an oral irrigator body, a pump assembly and a nozzle, where an oral irrigator water tank is slidably clamped in the oral irrigator body, the pump assembly is installed in the oral irrigator body, an oral irrigator inner cover is installed in the oral irrigator body, an end of the oral irrigator body is provided with an oral irrigator upper cover detachably connected to the oral irrigator body, a first magnet is installed in the oral irrigator upper cover, the oral irrigator upper cover is provided with a first opening for inserting the nozzle, an end of the nozzle is sleeved with a second magnet adsorbing and matching with the first magnet, and the pump assembly is configured to pump water from the oral irrigator water tank and spray water out from the nozzle.

In an embodiment, the oral irrigator upper cover includes a first upper cover and a second upper cover connected in sequence, and the first upper cover is provided with a first accommodation cavity configured to accommodate the first magnet.

In an embodiment, a third magnet is installed in the second upper cover, and a fourth magnet adsorbing and matching with the third magnet is installed in the oral irrigator inner cover.

In an embodiment, a pill configured as an irrigation medicine is provided in the oral irrigator inner cover, and a filter is installed in the second upper cover.

In an embodiment, the oral irrigator inner cover is provided with a storage cavity configured to accommodate the nozzle.

In an embodiment, the oral irrigator inner cover is provided with a pressure relief hole.

In an embodiment, one end of the oral irrigator body is sleeved with a sealing ring configured to seal the oral irrigator water tank.

In an embodiment, the sealing ring includes a sealing body arranged in an O-shape, and an outer side wall of the sealing body is provided with a sealing protrusion for sealing and waterproofing the oral irrigator water tank.

In an embodiment, the pump assembly includes a first installation bracket and a second installation bracket, a driving pump and a battery are provided between the first installation bracket and the second installation bracket, a water inlet of the driving pump is connected to the oral appliance water tank through a pipeline, and a water outlet of the driving pump is communicated with the oral irrigator inner cover through a diverter pipe.

In an embodiment, the diverter pipe includes a first connecting pipe and a second connecting pipe connected to the first connecting pipe, the first connecting pipe communicates with a water outlet of the driving pump through a pipe, the second connecting pipe is communicated with the oral irrigator inner cover, the diverter pipe is connected with a one-way valve, and an outlet of the one-way valve is provided in the second connecting pipe.

In the present application, the first magnet is installed in the oral irrigator upper cover. One end of the nozzle is sleeved with a second magnet adsorbing and matching with the first magnet. The pump assembly pumps water from the oral irrigator water tank, and water is sprayed out from the nozzle, thereby providing a portable oral irrigator. The nozzle is magnetically connected to the oral irrigator, which facilitates the disassembly and assembly of the nozzle, prevents the nozzle from being worn, and extends the service life of the nozzle.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a schematic three-dimensional structural diagram of a portable oral irrigator according to an embodiment of the present application.

FIG. 2 is a schematic exploded structural diagram of a portable oral irrigator according to an embodiment of the present application.

FIG. 3 is a schematic exploded structural diagram of the pump assembly in a portable oral irrigator according to an embodiment of the present application.

FIG. 4 is a schematic diagram of the partial structure of a portable oral irrigator according to an embodiment of the present application.

FIG. 5 is another schematic diagram of the partial structure of a portable oral irrigator according to an embodiment of the present application.

FIG. 6 is a schematic exploded structural diagram of an oral irrigator upper cover of a portable oral irrigator according to an embodiment of the present application.

FIG. 7 is a schematic half-section structural diagram of an oral irrigator upper cover of a portable oral irrigator according to an embodiment of the present application.

FIG. 8 is a schematic exploded structural diagram of a diverter pipe in a portable oral irrigator according to an embodiment of the present application.

FIG. 9 is a schematic exploded structural diagram of an oral irrigator water tank of a portable oral irrigator according to an embodiment of the present application.

FIG. 10 is a schematic three-dimensional structural diagram of a sealing ring in a portable oral irrigator according to an embodiment of the present application.

FIG. 11 is a schematic partially exploded structural diagram of another portable oral irrigator according to an embodiment of the present application.

FIG. 12 is another schematic partially exploded structural diagram of another portable oral irrigator according to an embodiment of the present application.

### DETAILED DESCRIPTION OF THE EMBODIMENTS

In order to make the purpose, technical solutions and advantages of the present application more clear, the present application will be further described in detail below with reference to the drawings and embodiments. It should be understood that the embodiments described here are only used to explain the present application and are not used to limit the present application.

In the present application, it should be noted that unless otherwise clearly specified and limited, the terms “connected”, “fixed”, etc. should be interpreted broadly. For example, “fixed” can be a fixed connection, a detachable connection, or a whole; can be a mechanical connection or an electrical connection; may be directly connected, or indirectly connected through an intermediate medium, and may be the internal communication between two elements; can be a wireless connection or a wired connection. For those skilled in the art, the specific meaning of the above-mentioned terms in the present application can be understood according to specific circumstances.

In the description of the present application, it should be noted that terms “center”, “upper”, “lower”, “left”, “right”, “vertical”, “horizontal”, “inner”, “outer”, and the like, which are used to indicate orientation or positional relationship is based on the orientation or positional relationship shown in the drawings. It is only for the convenience of describing the present application and simplifying the description, and does not indicate or imply that the device or element referred to must have a specific orientation or be constructed or operated in a specific orientation, and therefore should not be understood as limitations on the present application. Furthermore, the terms “first”, “second”, and “third” are used for describing purposes only and cannot be understood as indicating or implying relative importance.

In addition, the technical features in different embodiments of the present application described below can be combined with each other as long as they do not conflict with each other.

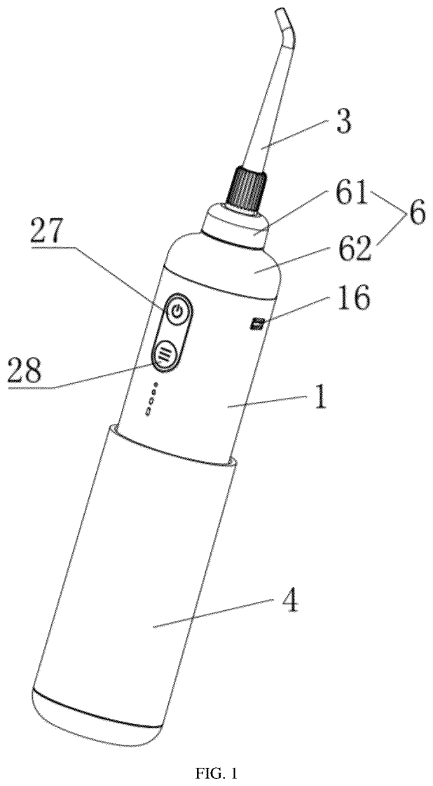

The embodiment of the present application discloses a portable oral irrigator, as shown in FIG. 1 to FIG. 12, which includes an oral irrigator body 1, a pump assembly 2 and a nozzle 3. An oral irrigator water tank 4 is slidably clamped in the oral irrigator body 1, the pump assembly 2 is installed in the oral irrigator body 1, and an oral irrigator inner cover 5 is installed in the oral irrigator body 1. An end of the oral irrigator body 1 is provided with an oral irrigator upper cover 6 detachably connected to the oral irrigator body 1, a first magnet 7 is installed in the oral irrigator upper cover 6, the oral irrigator upper cover 6 is provided with a first opening 611 for inserting the nozzle 3, and an end of the nozzle 3 is sleeved with a second magnet 8 adsorbing and matching with the first magnet 7. The pump assembly 2 is configured to pump water from the oral irrigator water tank 4 and spray water out from the nozzle 3. In the specific implementation process, the first opening 611 is arranged in a circular shape, and the first magnet 7 and the second magnet 8 are both arranged in the annular shape. The outer diameter of the first magnet 7 is larger than the diameter of the first opening 611, and the outer diameter of the second magnet 8 is smaller than or equal to the diameter of the first opening 611.

It should be noted that the first magnet 7 is installed in the oral irrigator upper cover 6. One end of the nozzle 3 is sleeved with a second magnet 8 adsorbing and matching with the first magnet 7. The pump assembly 2 pumps water from the oral irrigator water tank 4, and water is sprayed out from the nozzle 3, thereby providing a portable oral irrigator. The nozzle 3 is magnetically connected to the oral irrigator, which facilitates the disassembly and assembly of the nozzle 3, prevents the nozzle 3 from being worn, and extends the service life of the nozzle 3.

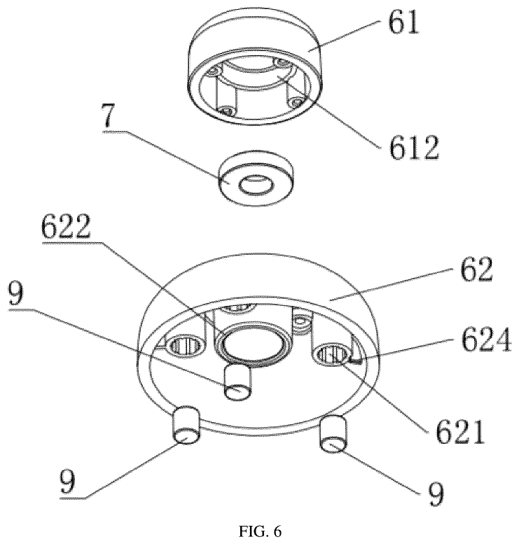

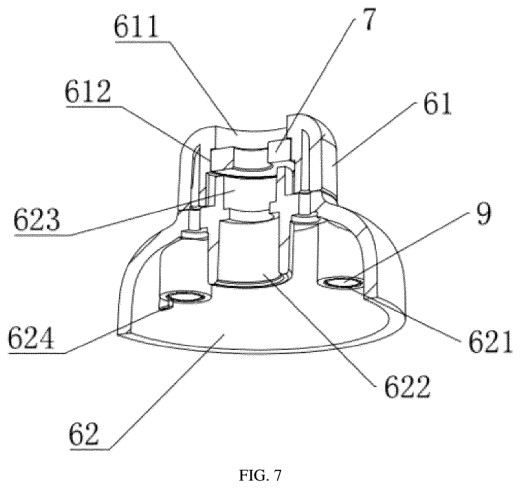

As shown in FIG. 6 and FIG. 7, the oral irrigator upper cover 6 includes a first upper cover 61 and a second upper cover 62 connected in sequence. The first upper cover 61 is provided with a first accommodation cavity 612 for accommodating the first magnet 7. In the specific implementation process, the first upper cover 61 is connected to the second upper cover 62 by screws.

As shown in FIG. 6 and FIG. 7, the third magnet 9 is installed in the second upper cover 62, and the fourth magnet 10, which adsorbs and matches with the third magnet 9, is installed in the oral irrigator inner cover 5. During the specific implementation, the second upper cover 62 is provided with a second accommodation cavity 621 for accommodating the third magnet 9, and the oral irrigator inner cover 5 is provided with a third accommodation cavity 53 for accommodating the fourth magnet 10. The number of the third magnets 9 and the fourth magnets 10 is both set to three, and both the third magnets 9 and the fourth magnets 10 are arranged in the cylindrical shape.

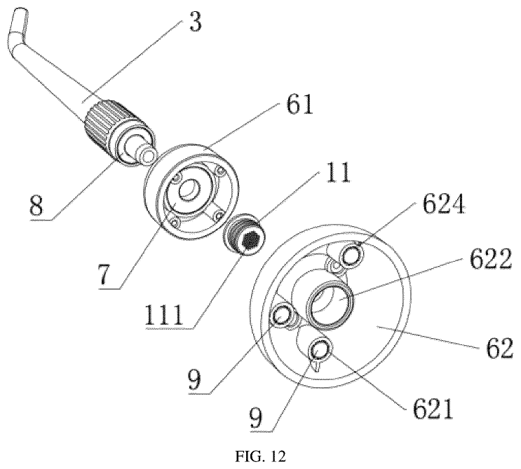

As shown in FIG. 11 and FIG. 12, pills configured as irrigation medicines are provided in the oral irrigator inner cover 5, and a filter 11 is installed in the second upper cover 62. In specific implementation, the pills may be whitening pills. A plurality of filter holes 111 are punched at the bottom of the filter 11, and the water inlet of the nozzle 3 is inserted into the filter 11. The water in the oral irrigator water tank 4 is pumped by the driving pump 23, and impacts the whitening pills to form a whitening liquid containing small whitening particles. The whitening liquid is sprayed out through the nozzle 3. Since the whitening liquid rubs the foreign matter attached to the teeth, the teeth are rubbed for whitening.

It should also be noted that the pills can also be the anti-inflammatory pill or the breath freshening pill.

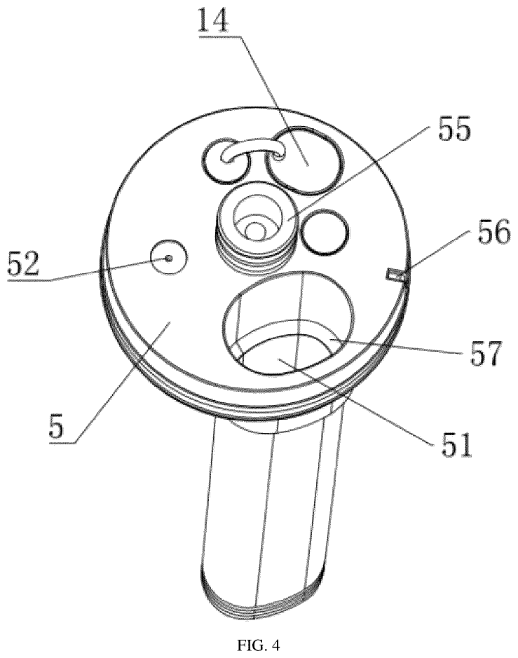

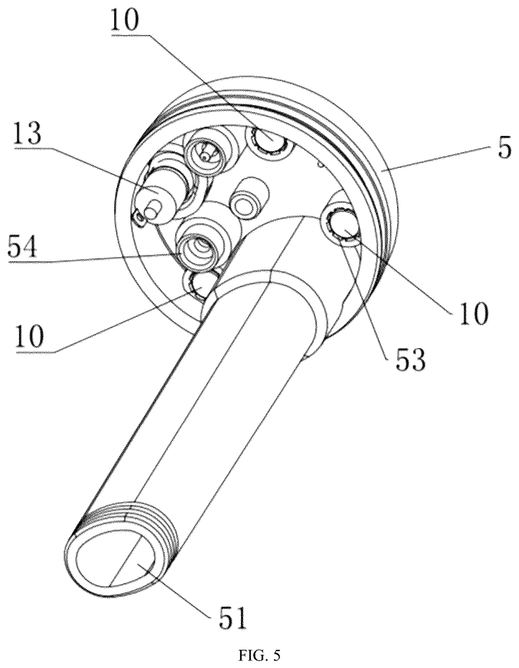

As shown in FIG. 4 and FIG. 5, the oral irrigator inner cover 5 is provided with a storage cavity 51 for accommodating the nozzle 3. In the specific implementation process, the cross section of the storage cavity 51 is arranged in an elliptical shape, and the storage cavity 51 is provided with a step 57 that overlaps the inverted nozzle 3. The arrangement of the storage cavity 51 facilitates storage of the nozzle 3, and the oral irrigator upper cover 6 is sleeved with a protective cover for covering the first opening 611.

As shown in FIG. 4 and FIG. 5, the oral irrigator inner cover 5 is provided with a pressure relief hole 52. In the specific implementation process, the oral irrigator inner cover 5 is provided with a positioning groove 56, and the second upper cover 62 is provided with a positioning block 624 that matches with the positioning groove 56. Both the positioning groove 56 and the positioning block 624 are arranged in an L-shape. It should be noted that the pressure relief function of the pressure relief hole 52 can balance the internal and external air pressure of the oral irrigator, and the pressure relief hole 52 can also play the role of explosion relief. When the battery 24 explodes during charging, the air pressure generated by the explosion will be discharged from the pressure relief hole 52.

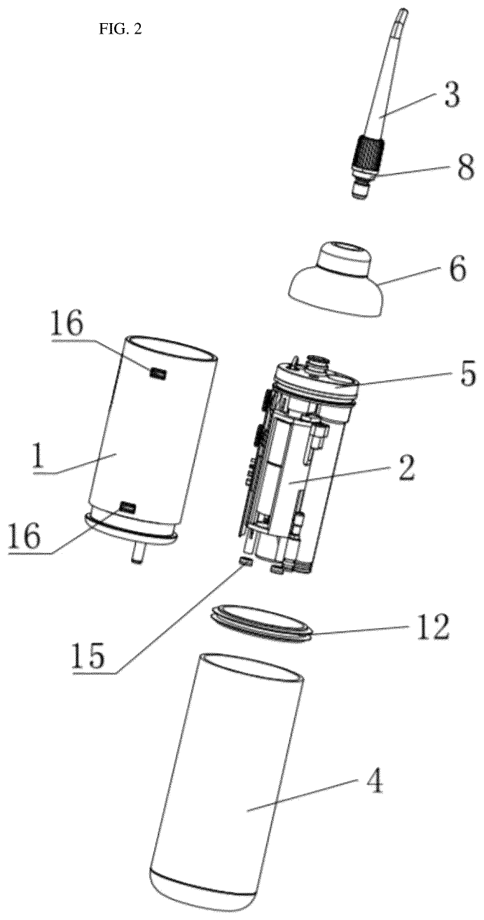

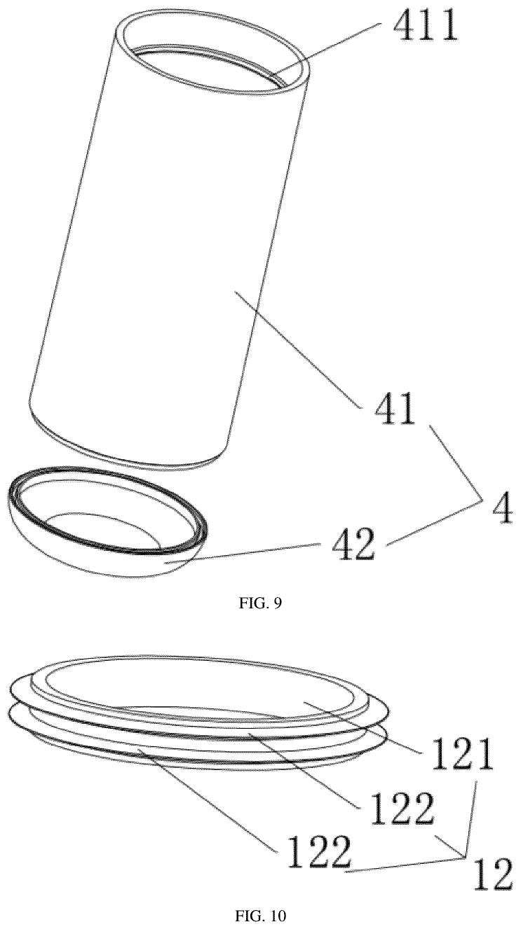

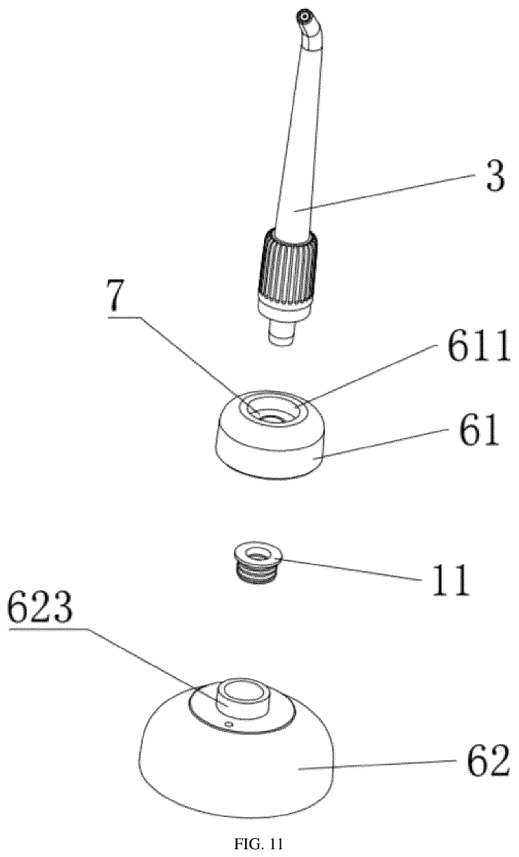

As shown in FIG. 2, FIG. 9 and FIG. 10, a sealing ring 12 for sealing the oral irrigator water tank 4 is sleeved on one end of the oral irrigator body 1. In the specific implementation process, the oral irrigator water tank 4 includes a first water tank shell 41 and a second water tank shell 42. The first water tank shell 41 and the second water tank shell 42 are bonded or ultrasonic welded. The first water tank shell 41 and the second water tank shell 42 are made of transparent plastic material. The inner wall of the first water tank shell 41 is provided with a clamping strip 411, and the oral irrigator body 1 is provided with a clamping slot 16 that matches with the clamping strip 411. The sealing ring 12 plays a waterproof role and can effectively seal the oral irrigator water tank 4.

As shown in FIG. 2 and FIG. 10, the sealing ring 12 includes a sealing body 121 arranged in the O-shape. The outer side wall of the sealing body 121 is provided with at least two layers of sealing protrusions 122. In the specific implementation process, the sealing body 121 and the sealing protrusion 122 are an integrally formed structure, and the cross section of the sealing protrusion 122 is in the conical shape.

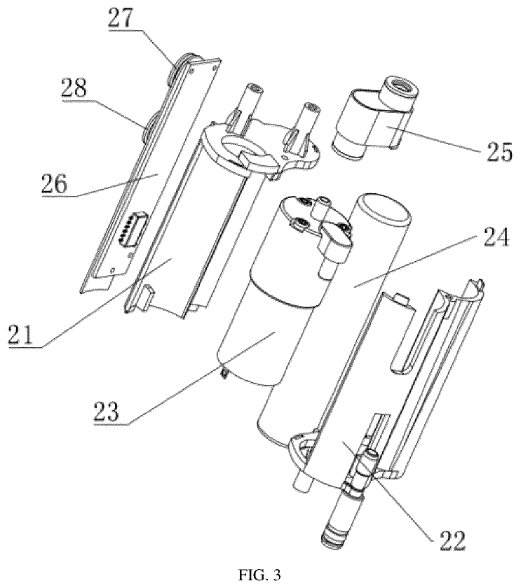

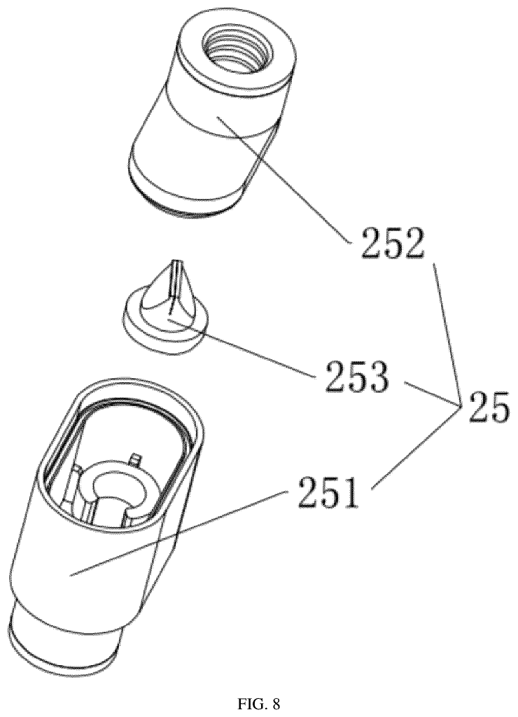

As shown in FIG. 3, FIG. 5 and FIG. 8, the pump assembly 2 includes a first installation bracket 21 and a second installation bracket 22. A driving pump 23 and a battery 24 are arranged between the first installation bracket 21 and the second installation bracket 22. The water inlet of the driving pump 23 is connected to the oral irrigator water tank 4 through a pipeline, and the water outlet of the drive pump 23 is connected to the oral irrigator inner cover 5 through the diverter pipe 25. In the specific implementation process, the driving pump 23 is a diaphragm pump, and the oral irrigator inner cover 5 is provided with a charging base 13 for charging the battery 24 by connecting an external power source. The charging base 13 is a direct current charging base 13. The oral irrigator inner cover 5 is provided with a waterproof cover 14 for covering the charging base 13. The waterproof cover 14 can be made of silicone material. A shock absorbing pad 15 for absorbing the shock of the oral irrigator is installed at one end of the first installation bracket 21. A control board 26 for controlling the working state of the oral irrigator is installed in the oral irrigator body 1. A switch button 27 and a mode button 28 are installed on the control board 26 in sequence. The control board 26 is electrically connected to a display light for displaying the state of the oral irrigator. The display light is the white LED light.

As shown in FIG. 3, FIG. 5 and FIG. 8, the diverter pipe 25 includes a first connecting pipe 251 and a second connecting pipe 252 that are connected to each other. The first connecting pipe 251 is connected to the water outlet pipeline of the driving pump 23. The second connecting pipe 252 is connected to the oral irrigator inner cover 5. A one-way valve 253 is installed in the first connecting pipe 251, and the outlet of the one-way valve 253 is provided in the second connecting pipe 252.

It should be noted that, as shown in FIG. 4 to FIG. 7, the oral irrigator inner cover 5 is provided with a first intubation pipe 54 and a second intubation pipe 55 that communicate with each other. The first intubation pipe 54 and the second connecting pipe 252 are plugged and matched with each other. The second upper cover 62 is provided with a third intubation pipe 622 and a fourth intubation pipe 623 that communicate with each other. The third intubation pipe 622 is plugged in and matched with the second intubation pipe 55, and the water inlet of the nozzle 3 is plugged in and matched with the fourth intubation pipe 623. The inner diameter of the first intubation pipe 54 is smaller than the inner diameter of the second intubation pipe 55. The inner diameter of the third intubation pipe 622 is larger than the inner diameter of the fourth intubation pipe 623. The oral irrigator inner cover 5, the first intubation pipe 54 and the second intubation pipe 55 are of the integrally formed structure. The second upper cover 62, the third intubation pipe 622 and the fourth intubation pipe 623 are of the integrally formed structure.

It should also be noted that, as shown in FIG. 11 and FIG. 12, the whitening pills are placed in the second intubation pipe 55, and the filter 11 is installed in the fourth intubation pipe 623. The water in the oral irrigator water tank 4 is pumped by the driving pump 23, and water will impact the whitening pills to form a whitening liquid containing small whitening particles. The whitening liquid is sprayed out through the nozzle 3. Since the whitening liquid rubs the foreign matter attached to the teeth, the teeth are rubbed for whitening.

As for the working principle, the first magnet 7 is installed in the oral irrigator upper cover 6. One end of the nozzle 3 is sleeved with a second magnet 8 adsorbing and matching with the first magnet 7. The pump assembly 2 pumps water from the oral irrigator water tank 4, and water will be sprayed out from the nozzle 3, thereby providing a portable oral irrigator. The nozzle 3 is magnetically connected to the oral irrigator, which facilitates the disassembly and assembly of the nozzle 3, and prevents the nozzle 3 from being worn. The service life of the nozzle 3 is extended.

Obviously, the above-mentioned embodiments are only examples for clear explanation and are not intended to limit the implementation. For those skilled in the art, other different forms of changes or modifications can be made based on the above description. An exhaustive list of all implementations is neither necessary nor possible. The obvious changes or modifications derived therefrom shall still fall within the scope of the present application.

What is claimed is:

1. A portable oral irrigator, comprising an oral irrigator body, a pump assembly and a nozzle, wherein an oral irrigator water tank is slidably clamped in the oral irrigator body, the pump assembly is installed in the oral irrigator body, an oral irrigator inner cover is installed in the oral irrigator body, an end of the oral irrigator body is provided with an oral irrigator upper cover detachably connected to the oral irrigator body, a first magnet is installed in the oral irrigator upper cover, the oral irrigator upper cover is provided with a first opening for inserting the nozzle, an end of the nozzle is sleeved with a second magnet adsorbing and matching with the first magnet, and the pump assembly is configured to pump water from the oral irrigator water tank and spray water out from the nozzle.

2. The portable oral irrigator of claim 1, wherein the oral irrigator upper cover comprises a first upper cover and a second upper cover connected in sequence, and the first upper cover is provided with a first accommodation cavity configured to accommodate the first magnet.

3. The portable oral irrigator of claim 2, wherein a third magnet is installed in the second upper cover, and a fourth magnet adsorbing and matching with the third magnet is installed in the oral irrigator inner cover.

4. The portable oral irrigator of claim 2, wherein a pill configured as an irrigation medicine is provided in the oral irrigator inner cover, and a filter is installed in the second upper cover.

5. The portable oral irrigator of claim 1, wherein the oral irrigator inner cover is provided with a storage cavity configured to accommodate the nozzle.

6. The portable oral irrigator of claim 1, wherein the oral irrigator inner cover is provided with a pressure relief hole.

7. The portable oral irrigator of claim 1, wherein one end of the oral irrigator body is sleeved with a sealing ring configured to seal the oral irrigator water tank.

8. The portable oral irrigator of claim 7, wherein the sealing ring comprises a sealing body arranged in an O-shape, and an outer side wall of the sealing body is provided with a sealing protrusion for sealing and waterproofing the oral irrigator water tank.

9. The portable oral irrigator of claim 1, wherein:
the pump assembly comprises a first installation bracket and a second installation bracket, a driving pump and a battery are provided between the first installation bracket and the second installation bracket, a water inlet of the driving pump is connected to the oral appliance water tank through a pipeline, and a water outlet of the driving pump is communicated with the oral irrigator inner cover through a diverter pipe.

10. The portable oral irrigator of claim 9, wherein:
the diverter pipe comprises a first connecting pipe and a second connecting pipe connected to the first connecting pipe, the first connecting pipe communicates with a water outlet of the driving pump through a pipe, the second connecting pipe is communicated with the oral irrigator inner cover, the diverter pipe is connected with a one-way valve, and an outlet of the one-way valve is provided in the second connecting pipe.
